(19) United States
(12) Patent Application Publication
(10) Pub. No.: US 2002/0100217 A1
(43) Pub. Date: Aug. 1, 2002

(54) Door panel assembly

(76) Inventors: Mark Graham Lawrie, (US); Yann Le Gallo, Orleans (FR); Pascal de Vries, Sandillion (FR); Klaus B. Wilhelm Blume, Frankfurt (DE); Charles Berry Hopson, Lebanon, TN (US); Herve Laurandel, St. Claire (FR); Simon Blair Dobson, Kent (GB); Damien Cahanne, Fountainebleau (FR)

Correspondence Address: CARLSON, GASKEY & OLDS, P.C., 400 WEST MAPLE ROAD, SUITE 350, BIRMINGHAM, MI, 48009, US

(21) Appl. No.: 10/025,385

(22) Filed: Dec. 19, 2001

(30) Foreign Application Priority Data
Jan. 12, 2001 (GB) 100822.6

(51) Int. Cl. E05F 11/48

(52) U.S. Cl. 49/332; 74/505; 74/89.22

(57) ABSTRACT

A door panel assembly including a door panel having a first and second side, a drive mechanism being mounted on the first side of the door panel and having an output shaft on which is mounted a window regulator cable drum, and a window regulator cable drum housing being mounted on the second side of the door panel and being made of metal and having at least one integral cable support.

### BACKGROUND OF THE INVENTION

The present invention relates to door panel assemblies and in particular door panel assemblies including window regulator cable drum housings for use in vehicles such as cars (automobiles).

Known window regulator cable drum housings are complicated in nature and include intricate shapes. In order to economically provide such components they are made as mouldings from a plastics material.

### SUMMARY OF THE INVENTION

An object of the present invention is to provide an improved form of window regulator housing cable drum housing.

Thus according to the present invention there is provided a door panel assembly including a door panel having a first and second side, a drive mechanism being mounted on the first side of the door panel and having an output shaft on which is mounted a window regulator cable drum, and a window regulator cable drum housing being mounted on the second side of the door panel and being made of metal and having at least one integral cable support.

### BRIEF DESCRIPTION OF THE DRAWINGS

The invention will now be described, by way of example only, with reference to the accompanying drawings in which:

FIG. 1 is a isometric view of some components of a door panel assembly according to the present invention;

FIG. 2 is a sectional view of part of FIG. 1;

FIG. 3 is a view of the pipe support of FIG. 1 prior to forming;

FIG. 4 is a sectional view of the cable drum housing of FIG. 1 including a cable drum; and

FIG. 5 is a section view of a door panel assembly of FIG. 1.

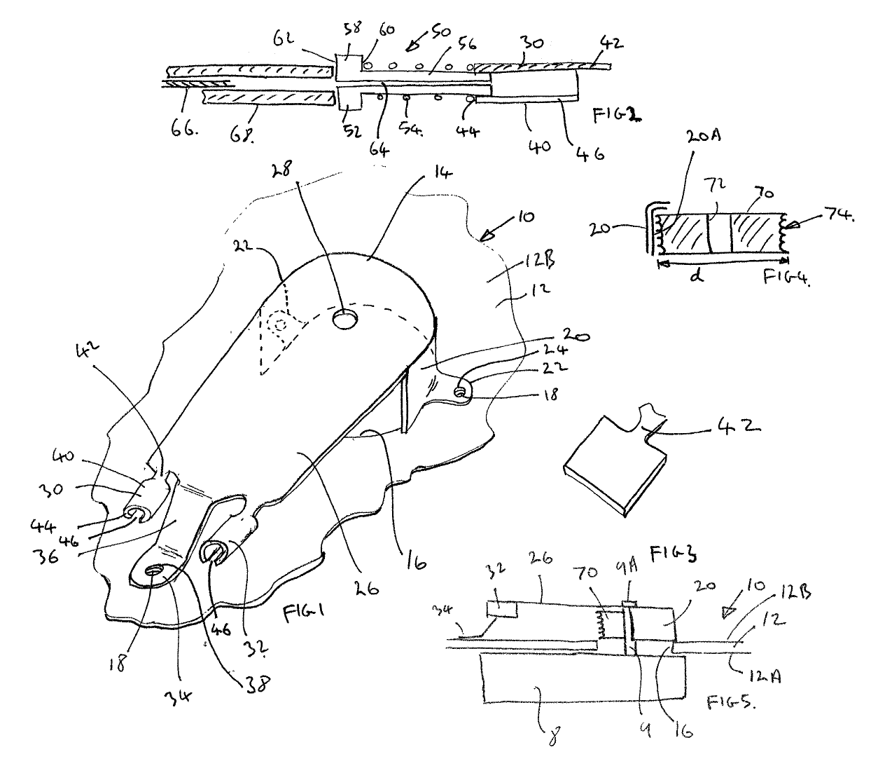

### DETAILED DESCRIPTION OF THE PREFERRED EMBODIMENT

With reference to the figures there is shown a door panel assembly 10 including a door panel 12, a window regulator cable drum housing 14 and a drive mechanism in the form of a window regulator motor 8.

Door panel 12 would typically be in the form of an inner panel pressing which is connected to an outer door skin to provide for a door structure of a vehicle such as a car (automobile). Alternatively the door panel could be in the form of a door panel module mounting plate (also known as a carrier plate) upon which is mounted various components of the door. The module mounting plate then been secured in a relative large aperture of the inside of an associated door.

Alternatively the door inner panel may be a window regulator motor mounting plate. The door panel 12 includes a circular hole 16 and mounting holes 18.

The door panel 12 includes a first side 12A on which is mounted the window regulator motor 8 and a second side 12B on which is mounted the window regulator cable drum housing 14.

Window regulator motor 8 includes a shaft 9 which projects through hole 16, and upon which is mounted cable drum 70. The end 9A of shaft 9 projects through and is supported by hole 28 of the cable drum housing 14 (further described below).

The cable drum housing 14 is made from metal, in this case sheet steel. The cable drum housing 14 includes an arcuate wall 20 which is formed by pressing and which extends for approximately 180 degrees about an axis as defined by hole 28 (see below). Bent from arcuate wall 20 are tabs 22 each having a mounting hole 24 which align with corresponding mounting holes 18.

Suitable fixing means such as bolts can be inserted through holes 18 and 24 to secure the cable drum housing 14 to the door panel 12. Depending upon the installation, some of the bolts can also be used to secure the motor 8 to the door panel 12. Alternatively the motor 8 can be provided with an independent fixing arrangement.

A cover 26 is integral with the arcuate wall 20 at a position remote from tabs 22. Covering 26 is generally planar and includes a shaft support portion in the form of a hole 28. Hole 28 is positioned at the centre of the ark defining arcuate wall 20 and also in line with the centre of the hole 16.

At the end of cover 26 remote from hole 28 there is provided two integral cable supports 30 and 32 and also a tab 34 connected to cover 26 by an angled portion 36. Tab 34 includes a mounting hole 38 which aligns with an associated mounting hole 18.

Tabs 22 and 34 are in the same general plane, though in further embodiments this need not be the case.

Cable supports 30 and 32 are generally similar and as such only cable support 30 will be described in detail. Cable support 30 includes a generally cylindrical portion 40 connected to the cover 26 by a wasted connecting portion 42. The cylindrical portion includes an end abutment 44 and further includes a longitudinal slot 46. In this case the cable supports 30 and 32 are formed by rolling a sheet metal blank. FIG. 3 shows that portion of the sheet metal blank which forms one of the cable supports prior to the rolling process.

FIG. 2 shows a cable tensioner 50 which includes a cable guide pipe 52 and a resilient means in the form of a helical compression spring 54. Cable guide pipe 52 is made from a plastics material and includes a reduced diameter portion 56 for sliding engagement within cable support 30, and a enlarged diameter portion 58 which provides a spring abutment 60 and a cable outer abutment 62.

Cable guide 52 further includes a central hole 64 through which passes cable 66. Cable 66 includes a cable sheath 68.

Consideration of FIGS. 4 and 5 shows the cable drum 70 has a central hole and a threaded circumferential surface 74. The thread profile is substantially semicircular to correspond with the circular profile of the cable 66. In use cable drum 70 is positioned in the cable drum housing 14 with hole 72 being aligned with hole 28 such that shaft 9 passes through both of these holes.

Cable 66 passes through the cable tensioner associated with cable supports 30 and extends towards to the cable drum and is wound around the cable drum a number of times with the end being secured to the cable drum. The other end of cable 66 passes through the other cable tensioner associated with cable support 32 and extends towards the cable drum and is wound around the cable drum a number of times with the end being secured thereto.

It can be seen that the cable supports 30 and 32 are generally situated remote from the cable drum 70 and tangentially orientated relative to the threaded circumferential surface 74. The diameter d of the cable drum 70 is such that the threaded circumferential surface 74 is positioned close to the inner surface 20A of arcuate wall 20. Thus the inner surface 20A acts as a cable guide to ensure that each turn of cable around the drum remains in its appropriate thread.

It should further be noted that tab 34 is positioned circumferentially between cable support 30 and cable support 32 when considering the axis of the cable drum 70.

In further embodiments the drive mechanism could be a manual window winder mechanism.

In further embodiments there may be a bayonet type of fitting arrangement between the door panel and the window regulator cable drum housing to replace or compliment tabs 22 and 34.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A door panel assembly comprising:
a door panel having a first and a second side, a drive mechanism being mounted on the first side of the door panel and having an output shaft on which is mounted a window regulator cable drum, and a window regulator cable drum housing being mounted on the second side of the door panel and being made of metal and having at least one integral cable support.

2. The door panel assembly as defined in claim 1 in which the cable drum housing is made from sheet metal.

3. The door panel assembly as defined in claim 1 in which the cable drum housing is made from steel.

4. The door panel assembly as defined in claim 1 in which the cable drum housing including an arcuate wall which in use acts as a cable guide.

5. The door panel assembly as defined in claim 1 in which the cable drum housing includes a shaft support portion which in use supports the output shaft.

6. The door panel assembly as defined in claim 1 in which the cable drum housing includes attachment features in the form of one or more tabs.

7. The door panel assembly as defined in claim 1 in which the cable drum housing includes attachment features in the form of a bayonet fitting arrangement.

8. The door panel assembly as defined in claim 1 in which at least one integral cable support is formed of rolled sheet metal.

9. The door panel assembly as defined in claim 8 in which the at least one integral cable support includes a slot sized to allow an associated cable to pass therethrough.

10. The door panel assembly as defined in claim 1 including at least one cable guide pipe mounted in the at least one integral cable support.

11. The door panel assembly as in claim 10 in which the cable guide pipe is made of plastic.

12. The door panel assembly as defined in claim 1 further including a cable tensioner having a resilient member in which the at least one integral cable support includes an abutment surface for engagement by the resilient member.

13. The door panel assembly as defined in claim 12 including at least one cable guide pipe mounted in the at least one integral cable support in which the resilient member acts against the abutment surface of the at least one integral cable support and reacts against an abutment surface of the cable guide pipe.

14. The door panel assembly as defined claim 1 including two integral cable supports.

15. The door panel assembly as defined in claim 14 in which the cable drum housing includes attachment features having a portion situated between the integral cable supports.
